(19) United States
(12) Patent Application Publication
(10) Pub. No.: US 2013/0209796 A1
(43) Pub. Date: Aug. 15, 2013

(54) POLYCARBONATE WITH HARD COAT LAYER

(71) Applicants: Hiroaki Yamada, Kisarazu-shi (JP); Yoshihisa Goto, Kisarazu-shi (JP); Hideo Asano, Kisarazu-shi (JP); Keiichi Hayashi, Kitakyushu-shi (JP)

(72) Inventors: Hiroaki Yamada, Kisarazu-shi (JP); Yoshihisa Goto, Kisarazu-shi (JP); Hideo Asano, Kisarazu-shi (JP); Keiichi Hayashi, Kitakyushu-shi (JP)

(21) Appl. No.: 13/881,635

(22) PCT Filed: Oct. 27, 2011
(86) PCT No.: PCT/JP2011/074748

§ 371 Date: Apr. 25, 2013

(30) Foreign Application Priority Data
Nov. 4, 2010 (JP) 2010-247242

(51) Int. Cl. B32B 27/08

(52) U.S. Cl. CPC B32B 27/08
USPC 428/339

(57) ABSTRACT

Provided is a polycarbonate with a hard coat layer, which is excellent in transparency, high surface hardness, weather resistance, chemical resistance, durability, and heat resistance. The polycarbonate with a hard coat layer includes a hard coat film (1 and 4) bonded to a base (3) formed of a polycarbonate resin via an adhesive layer (2), in which the hard coat film includes, on an outermost surface, a resin layer (4) that is obtained by curing a photocurable resin composition containing at least a photocurable polyhedral silsesquioxane resin and that has a light transmittance at a wavelength of 550 nm of 90% or more, a glass transition temperature of 250° C. or more, and a thickness of 10 μm or more and 200 μm or less.

### TECHNICAL FIELD

The present invention relates to a polycarbonate with a hard coat layer. Specifically, the present invention relates to a polycarbonate with a hard coat layer, which is excellent in transparency, high surface hardness, weather resistance, chemical resistance, and durability, and is suitable for architectural and various industrial applications including a display device such as a CRT display, a liquid crystal display, a plasma display, or an organic EL display, protective glass, window glass for a building material, and window glass for a vehicle.

### BACKGROUND ART

Glass is excellent in light transmittance, gas barrier property, dimensional property, and the like, and is hence used in various applications. In particular, in a field of a flat display typified by, for example, a CRT display, a liquid crystal display, a plasma display, or an organic EL display, very high-performance and expensive glass is provided. However, in such applications, to meet demands for reductions in thickness, weight, and cost of the flat display, an attempt has been made to use a plastic such as a lightweight and inexpensive polycarbonate resin instead of the glass. However, the polycarbonate resin or the like has low surface hardness and is liable to cause a surface flaw compared to the glass, and hence, in order to prevent the flaw, it is necessary to protect the surface of the resin by applying a coating to the surface or by bonding a curable film to the surface.

For example, JP 2008-260202 A (Patent Literature 1) describes an invention which relates to a hard coat film for injection molding, which includes a base layer formed of a mixed resin composition including a polycarbonate resin and a polyester resin, and a hard coat layer formed of a cured material of an ultraviolet curable resin composition including an acrylic polymer. Further, JP 2002-1759 A (Patent Literature 2) describes an invention which relates to a production method for a molding of a polycarbonate uresin, which includes applying a curable coating agent to a resin film, semicuring the coating agent, setting the semicured coating film in a mold, injection-molding the polycarbonate resin, peeling-off the resin film, and further curing the coating agent to cure the surface. In Patent Literature 2, a silicone-based coating agent obtained by adding colloidal silica to an organosilane having a structure of RₙSi(OH)₄₋ₙ or an acrylic coating agent is listed as a preferred example.

### CITATION LIST

### Patent Literature

[PTL 1] JP 2008-260202 A
[PTL 2] JP 2002-1759 A

### SUMMARY OF INVENTION

### Technical Problem

However, a conventional method involving forming a hard coat layer or using a coating agent is unsatisfactory in view of its reliability, performance, and cost, because of insufficient adhesion to a polycarbonate used as a base, insufficient surface hardness, or necessity of a special molding method, and has a problem in that, for example, properties required in the field of the flat display or in the field of window glass for a vehicle cannot be sufficiently satisfied.

An object of the present invention is to provide a polycarbonate with a hard coat layer, which has high surface hardness and is excellent in mar resistance, transparency, weather resistance, chemical resistance, durability, and productivity.

### Solution to Problem

The inventors of the present invention have made intensive studies to solve the above-mentioned problem, and as a result, have found that a polycarbonate with a hard coat layer, which is excellent in transparency, high surface hardness, weather resistance, chemical resistance, durability, and productivity, can be obtained by producing a laminate obtained by forming a resin layer having, on the outermost surface, at least a photocurable polyhedral silsesquioxane resin on the surface of a base formed of a polycarbonate resin having transparency, thus completing the present invention.

That is, the present invention is a polycarbonate with a hard coat layer, including a hard coat film bonded to a base formed of a polycarbonate resin via an adhesive layer, in which the hard coat film includes, on an outermost surface, a resin layer that is obtained by curing a photocurable resin composition containing at least a photocurable polyhedral silsesquioxane resin, and that has a light transmittance at a wavelength of 550 nm of 90% or more, a glass transition temperature of 250° C. or more, and a thickness of 10 μm or more and 200 μm or less.

In the polycarbonate with a hard coat layer of the present invention, the resin layer for forming the hard coat layer includes a layer obtained by curing a photocurable resin composition containing a photocurable polyhedral silsesquioxane resin.

Further, in the polycarbonate with a hard coat layer according to a preferred embodiment of the present invention, the photocurable resin composition for forming the resin layer contains the photocurable polyhedral silsesquioxane resin at a concentration of 3 wt % or more.

Further, in the polycarbonate with a hard coat layer according to a preferred embodiment of the present invention, the photocurable polyhedral silsesquioxane resin includes a polyhedral silsesquioxane resin represented by the following general formula (2):

[RSiO_{3/2}]ₙ (2)

where R represents an organic functional group having any one of a (meth)acryloyl group, a glycidyl group, or a vinyl group, and n represents 8, 10, 12, or 14).

Further, in the polycarbonate with a hard coat layer according to a preferred embodiment of the present invention, the photocurable polyhedral silsesquioxane resin includes a polyhedral silsesquioxane resin that is obtained by: hydrolyzing and partially condensing a silicon compound represented by the following general formula (1):

RSiX₃ (1)

Where R represents an organic functional group having any one of a (meth)acryloyl group, a glycidyl group, or a vinyl group, or the following general formula (3), (4), or (5):

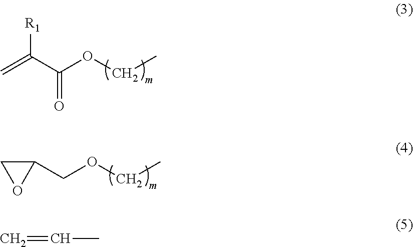

where m represents an integer of 1 to 3, and R₁ represents a hydrogen atom or a methyl group, and X represents a hydrolyzable group in the presence of an organic polar solvent and a basic catalyst; and recondensing the resultant hydrolysis product in the presence of a non-polar solvent and a basic catalyst.

### Advantageous Effects of Invention

The polycarbonate with a hard coat layer of the present invention is excellent in transparency, high surface hardness, weather resistance, chemical resistance, durability, and productivity. Therefore, the polycarbonate with a hard coat layer is suitable for architectural and various industrial applications including a display device such as a CRT display, a liquid crystal display, a plasma display, or an organic EL display, protective glass, window glass for a building material, and window glass for a vehicle.

### BRIEF DESCRIPTION OF DRAWINGS

FIG. 1 illustrates an example of a cross-sectional schematic view of a polycarbonate with a hard coat layer of the present invention.

### DESCRIPTION OF EMBODIMENTS

Hereinafter, preferred embodiments of a polycarbonate with a hard coat layer of the present invention are described in detail.

A resin layer to be used in the present invention as a hard coat layer of the polycarbonate with a hard coat layer is required to have a light transmittance at a wavelength of 550 nm of 90% or more and a glass transition temperature (upper temperature limit) of 250° C. or more. For forming such resin layer, a photocurable resin composition containing a photocurable polyhedral silsesquioxane resin is used. The content of the polyhedral silsesquioxane resin in the photocurable resin composition is preferably 3 wt % or more, more preferably from 5 to 30 wt %. When the content of the photocurable polyhedral silsesquioxane resin is less than 3 wt %, a film laminate to be obtained has poor heat resistance when used in the flat display field.

The resin layer to be laminated on a transparent plastic film has a light transmittance at a wavelength of 550 nm of 90% or more. When the light transmittance is less than 90%, the layer has poor light transmission property, which may deteriorate, for example, visibility of shatterproof glass to impair design of an object to be protected. In addition, the glass transition temperature of the resin layer is 250° C. or more. When the glass transition temperature is less than 250° C., the layer has poor heat resistance when used in flat display and vehicle window glass fields, for example. The upper temperature limit of the resin layer to be laminated is preferably as high as possible, as long as it does not inhibit other properties of the resin layer to be laminated, i.e., transparency, high surface hardness, weather resistance, chemical resistance, and durability. However, from a practical standpoint, the upper limit of the glass transition temperature of the resin layer is about 500° C.

As the photocurable polyhedral silsesquioxane resin, the following compounds may be used, for example.

A first example is a polyhedral silsesquioxane resin obtained by: hydrolyzing and partially condensing a silicon compound represented by the following general formula (1):

RSiX₃ (1)

(where R represents an organic functional group having any one of a (meth)acryloyl group, a glycidyl group, or a vinyl group, and X represents a hydrolyzable group) in the presence of an organic polar solvent and a basic catalyst; and recondensing the resultant hydrolysis product in the presence of a non-polar solvent and a basic catalyst.

In addition, a second example is a polyhedral silsesquioxane resin represented by the following general formula (2):

[RSiO_{3/2}]ₙ (2)

(where R represents an organic functional group having any one of a (meth)acryloyl group, a glycidyl group, or a vinyl group, and n represents 8, 10, 12, or 14).

Further, a third example is a polyhedral silsesquioxane resin in which R in the general formula (1) in the first example represents an organic functional group represented by the following general formula (3), (4), or (5):

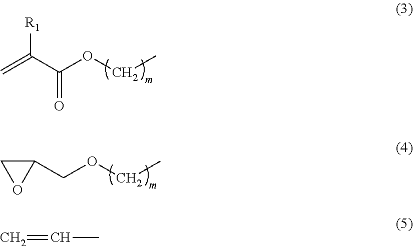

(where m represents an integer of 1 to 3, and R₁ represents a hydrogen atom or a methyl group).

In the present invention, the polyhedral silsesquioxane resin is preferably a polyhedral silsesquioxane resin that has controlled molecular weight distribution and molecular structure and has a reactive functional group including an organic functional group having a (meth)acryloyl group, a glycidyl group, or a vinyl group on each of all silicon atoms. The polyhedral silsesquioxane resin in the photocurable resin composition of the present invention may be a polyhedral silsesquioxane resin having controlled molecular weight distribution and molecular structure, a resin mixture including such polyhedral silsesquioxane resin as a major component (preferably 3 wt % or more) and another resin, or a resin mixture including components having different numbers of “n” in the structure represented by the formula (2). Further, the polyhedral silsesquioxane resin may be an oligomer. Here, in the resin mixture including the polyhedral silsesquioxane resin as a major component, a resin suitable for mixing is not particularly limited as long as it has compatibility and reactivity with the polyhedral silsesquioxane resin, and the resin is preferably, for example, a (meth)acrylate and epoxy resin or a urethane resin. In addition, a filler-based additive may be added to the photocurable resin composition as long as the additive does not inhibit photocurability.

Further, a photopolymerization initiator is usually blended in the photocurable resin composition. In addition, in the present invention, an appropriate solvent may be used as a diluent for, for example, adjusting the viscosity of the photocurable resin composition. However, the content of the solvent in the photocurable resin composition to be applied is preferably 5% or less because it takes time to perform a step of removing the solvent by volatilization, resulting in low production efficiency, and the solvent remaining in the resin layer obtained after curing or the like causes deterioration of characteristics of a molded film. The composition to be used is preferably one containing substantially no solvent.

The hard coat layer may be used as a single hard coat film including the resin layer that is formed of the photocurable resin composition or as a laminate of “resin layer-transparent plastic film” formed on a transparent plastic. In the single hard coat film or film laminate including the “resin layer-transparent plastic film,” the thickness of the resin layer to be obtained by curing the photocurable resin composition ranges from 10 to 200 μm, preferably from 20 to 150 μm. When the thickness of the resin layer is less than 10 μm, the surface hardness cannot be exerted sufficiently, while when the thickness exceeds 200 μm, the resin layer part may cause deformation or the like due to shrinkage by curing. In addition, in the film laminate including the “resin layer-transparent plastic film,” the ratio of the thickness of the resin layer to the thickness of the transparent plastic film (thickness of the resin layer÷thickness of the transparent plastic film) is preferably 0.1 or more and 5.0 or less. When the thickness ratio is less than 0.1, the object of improvement of the surface hardness of the transparent plastic film used as a base cannot be achieved because the resin layer is too thin to sufficiently exert the effect of high surface hardness, which is a feature of the photocurable resin composition. On the other hand, when the thickness ratio exceeds 5.0, the film laminate to be obtained may be easily damaged because the resin layer is too thick. Further, the photocurable resin composition may be applied to both surfaces of the transparent plastic film used as a base and cured to form a film laminate having a three-layer structure of “resin layer-transparent plastic film-resin layer”. As compared with the “resin layer-transparent plastic film” having the resin layer only on one surface, the film laminate can have further reduced warpage, deformation, and the like. It should be noted that, in the case where the resin layer is formed on both surfaces of the transparent plastic film, each resin layer preferably satisfies the conditions specified in the present invention. That is, for example, the ratio of the thickness of each resin layer to the thickness of the transparent plastic film is preferably adjusted to the above-mentioned range. Meanwhile, both the resin layers may be formed of the same component or different photocurable resin compositions to be applied to the respective surfaces.

In addition, the transparent plastic film preferably has a light transmittance at a wavelength of 550 nm of 80% or more. When the light transmittance is less than 80%, the film laminate has poor light transmission property, which may cause deterioration of visibility of the polycarbonate with a hard coat layer or may impair the design thereof. Further, the transparent plastic film to be used has a glass transition temperature (upper temperature limit) of 70° C. or more and 220° C. or less. When the glass transition temperature is less than 70° C., swell or warpage may appear due to heat under a high-temperature use environment for a vehicle or the like. When the upper temperature limit of the transparent plastic film exceeds 220° C., an intention to form a laminate structure together with the resin layer becomes smaller because the film has sufficient heat resistance. A material for such transparent plastic film may be exemplified by films based on polyethylene terephthalate (PET), polyethylene naphthalate (PEN), polybutylene phthalate (PBT), a cycloolefin polymer (COP), a cycloolefin copolymer (COC), polycarbonate (PC), acetate, acryl, vinyl fluoride, polyamide, polyarylate, cellophane, polyether sulfone, and a norbornene resin. Those films may each be used alone or may be used in combination of two or more kinds thereof. In particular, preferred are polyethylene terephthalate (PET), polyethylene naphthalate (PEN), a cycloolef in polymer (COP), and a cycloolef in copolymer (COC), each of which is excellent in heat resistance and transparency, and has a good balance among various properties. In addition, it is desirable to use a transparent plastic film which is excellent in adhesion property to the resin layer, and in order to improve the adhesion property to the resin layer, for example, the surface of the transparent plastic film may be subjected to a surface activation treatment such as a corona discharge treatment, an ultraviolet irradiation treatment, or a plasma treatment.

The transparent plastic film is required to have a thickness that satisfies the above-mentioned ratio of the thickness of the resin layer to the thickness of the transparent plastic film, and the thickness of the transparent plastic film alone is preferably 0.05 mm or more. When the thickness of the transparent plastic film is less than 0.05 mm, the resin layer may deform due to shrinkage in curing of the resin layer or may not endure a tension during application. It should be noted that the surface of the transparent plastic film may be flat or may have concavo-convex patterns. However, the surface of the transparent plastic film preferably has a shape which does not inhibit transparency.

The photocurable resin composition is a liquid, and hence can be applied with a known application device. However, an application head is desirably protected from ultraviolet light because gel-like matter on the application head may cause formation of lines or foreign substances when the application head is used in a curing reaction. As an application method, there may be employed a known method such as gravure coating, roll coating, reverse coating, knife coating, die coating, lip coating, doctor coating, extrusion coating, slide coating, wire bar coating, curtain coating, extrusion coating, or spin coating.

The photocurable resin composition is applied to the transparent plastic film, cast, and subjected to photocuring. In general, the photocuring is performed by an ultraviolet irradiation method. Usually, ultraviolet light may be generated by an ultraviolet lamp and used for irradiation. Examples of the ultraviolet lamp include a metal halide lamp, a high-pressure mercury lamp, a low-pressure mercury lamp, a pulsed xenon lamp, a xenon/mercury lamp, a low-pressure bactericidal lamp, and an electrodeless lamp. Any one of the ultraviolet lamps may be used. Of the ultraviolet lamps, a metal halide lamp or high-pressure mercury lamp is preferred. Although irradiation conditions vary depending on the conditions of the lamps, the amount of light exposure may be about from 20 to 10,000 mJ/cm² and is preferably from 100 to 10,000 mJ/cm². In addition, from the standpoint of efficient use of light energy, the ultraviolet lamp is preferably equipped with, for example, an elliptic, parabolic, or diffusional reflector, and may further be equipped with, for example, a heat cut filter for cooling.

Further, a site where irradiation by the ultraviolet lamp is performed preferably has a cooling device. The cooling device can suppress thermal deformation of the transparent plastic film or the like caused by a heat generated from the ultraviolet lamp. There may be employed a known cooling system such as an air-cooling system or a water-cooling system.

The ultraviolet curing reaction is a radical reaction and hence is inhibited by oxygen. Therefore, when the photocurable resin composition is applied to the transparent plastic film, cast, and subjected to photocuring, in order to prevent the inhibition by oxygen, a transparent cover film is put on the photocurable resin composition after the application and casting. The concentration of oxygen on the surface of the liquid photocurable resin that is cast and used as a raw material is preferably adjusted to 1% or less, more preferably 0.1% or less. In order to decrease the concentration of oxygen, it is necessary to employ a transparent cover film having no holes on its surface and having a small oxygen permeability. Examples of the transparent cover include films based on polyethylene terephthalate (PET), polycarbonate (PC), polypropylene, polyethylene, acetate, acryl, vinyl fluoride, polyamide, polyarylate, cellophane, polyether sulfone, and a norbornene resin, which may each be used alone or may be used in combination of two or more kinds thereof. However, the transparent cover film is required to be peelable from the photocurable resin composition. Therefore, the surface of the transparent cover film is preferably subjected to an easy peel-off treatment such as silicon application or fluorine application. Also in the case where the hard coat layer includes the resin layer alone, the transparent plastic film is subjected to the same easy peel-off treatment.

In the present invention, as a material for forming an adhesive layer that bonds the hard coat film (film laminate or resin layer alone) to a base formed of a polycarbonate resin, there are given photocurable resin type materials, a thermosetting resin type material, a two-component mixed reaction liquid type material, and a two-sided pressure-sensitive adhesive seal type material. Of those, photocurable resin type materials are classified into a radically curable material and a cationically curable material. Examples of the radically curable material include acrylic, en/thiol-based, and vinyl ether-based materials, and examples of the cationically curable material include epoxy-based, oxetane-based, and vinyl ether-based materials. Further, examples of the thermosetting resin type material include epoxy-based, phenol-based, and polyester-based materials. The above-mentioned various materials for the adhesive layer may be used and are not particularly limited, but the thermosetting resin type material and two-component mixed reaction liquid type material may require a long time for bonding by curing, and the two-sided pressure-sensitive adhesive seal type material may have poor adhesion property. Therefore, the layer formed of the photocurable resin is preferred because of excellent adhesion property to the film laminate and excellent productivity. The thickness of the adhesive layer is not particularly limited. For example, in the case of the adhesive layer formed of the photocurable resin, the thickness is usually 2 to 100 μm to sufficiently bond the hard coat film to the surface of the base.

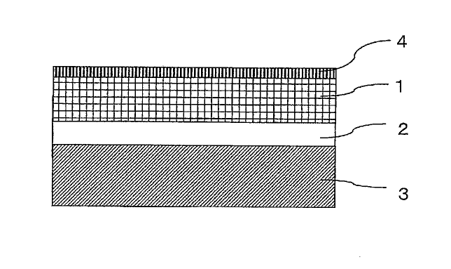

The method of bonding the hard coat film to the base by adhesion in the present invention is not particularly limited, and for example, there may be employed a method involving: applying or bonding a photocurable resin, a thermosetting resin, a two-component mixed reaction liquid, a two-sided pressure-sensitive adhesive seal, or the like to the surface of a base to provide an adhesive layer; laminating a hard coat film thereon using a pressure roller; and adhering them by a method suitable for each case. It should be noted that in the case where the hard coat layer includes two layers of the resin layer and the transparent plastic film, in order to exert the heat resistance, chemical resistance, and surface hardness, as illustrated in FIG. 1, the hard coat film is preferably bonded to a polycarbonate resin 3 such that the side of a transparent plastic film 1 faces an adhesive layer 2 to arrange a resin layer 4 on the outermost surface.

The polycarbonate to be used in the present invention is not particularly limited and may be appropriately selected depending on, for example, applications of the polycarbonate with a hard coat layer to be obtained. In the case where visibility through the polycarbonate with a hard coat layer is required, the polycarbonate is required to be transparent. However, the polycarbonate may have a color, a pattern, or the like depending on its function. In addition, the polycarbonate may be a flat plate or may have a predetermined curved surface.

### EXAMPLES

Hereinafter, the present invention is more specifically described by way of Examples and Comparative Examples. However, the present invention is not limited to the following examples. It should be noted that the expression “part(s)” in Examples and Comparative Examples means “part(s) by weight.”

### Example 1

80 parts of trimethylolpropane triacrylate (KS-TMPA, manufactured by NIPPON KAYAKU Co., Ltd.), 20 parts of a silsesquioxane oligomer (the following structural formula 1), and 2.5 parts of hydroxycyclohexyl phenyl ketone (IRGACURE 184, manufactured by Ciba Specialty Chemicals Inc.) were homogeneously mixed by stirring, and the mixture was defoamed to prepare a liquid photocurable resin composition. After that, the liquid photocurable resin composition was loaded into an application device and applied simultaneously onto both sides of a transparent plastic film (polyethylene terephthalate (PET) film having a width of 300 mm, a thickness of 0.1 mm, and a light transmittance at a wavelength of 550 nm of 90% or more) which was wound off at a rate of 1 m/min by a slot die coater method. Then, a transparent cover film (polyethylene terephthalate film having a width of 300 mm, a thickness of 0.1 mm, and a light transmittance of 900 or more) was pressure-bonded to the applied photocurable resin from both sides. The resultant was irradiated with ultraviolet light from both sides at a rate of 500 mJ/cm² using a metal halide lamp. The thickness of one of the resin layers obtained by curing was 0.05 mm. Subsequently, the transparent cover film was removed by peeling, thereby obtaining a film laminate (total thickness: 0.2 mm) having a three-layer structure of “resin layer (thickness: 0.05 mm)-transparent plastic film (thickness: 0.1 mm)-resin layer (thickness: 0.05 mm).” The reaction rate of each resin layer in the resultant film laminate was measured and found to be 85% or more. In addition, the resin layer alone was subjected to photocuring, and the light transmittance at a wavelength of 550 nm of the resultant resin layer was measured and found to be 91%. Further, the glass transition temperature of each resin layer was determined by differential scanning calorimetry and found to be 300° C. or more. In addition, the glass transition temperature of the transparent plastic film was determined by differential scanning calorimetry and found to be 72° C. Table 1 collectively shows the results.

### Structural Formula 1

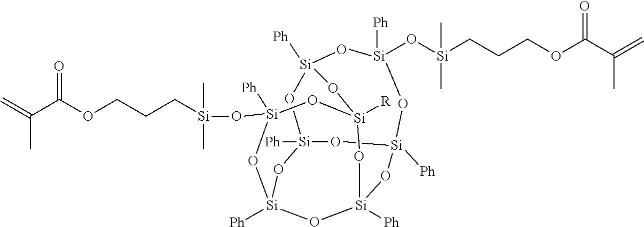

TABLE 1

| | | Exam- | Exam- | Exam- | Exam- |
|---|---|---|---|---|---|
| | | ple 1 | ple 2 | ple 3 | ple 4 |
| Resin layer | Light | 91 | 91 | 91 | 91 |
| | transmittance | | | | |
| | (%) | | | | |
| | Tg (° C.) | >300 | >300 | >300 | >300 |
| Transparent | Tg (° C.) | 72 | 72 | 72 | 72 |
| plastic film | | | | | |

| | | | | |
|---|---|---|---|---|
| Thickness of resin layer/ | 0.5 | 0.5 | 0.5 | 0.5 |
| Thickness of transparent | | | | |
| plastic film*¹ | | | | |

| | | Comparative | Comparative |
|---|---|---|---|
| | | Example 1 | Example 2 |
| Resin layer | Light | — | — |
| | transmittance | | |
| | (%) | | |
| | Tg (° C.) | — | — |
| Transparent | Tg (° C.) | 72 | 110 |
| plastic film | | | |

| | | |
|---|---|---|
| Thickness of resin layer/ | — | — |
| Thickness of transparent | | |
| plastic film*¹ | | |

*¹“Thickness of resin layer/Thickness of transparent plastic film” is a value which represents a ratio of “thickness of one resin layer” of two resin layers in each film laminate to “thickness of transparent plastic film.”

Then, a cationic photocurable adhesive (manufactured by Kyoritsu Chemical & Co., Ltd.) was applied by casting to a polycarbonate (PC-1151, manufactured by Teij in Limited, 200 mm×200 mm×0.5 mm in thickness) so as to have a thickness of 5 μm, and the film laminate obtained above (total thickness: 0.2 mm) was attached to the whole surface of one side of the polycarbonate, pressure-bonded, and irradiated with ultraviolet light from both sides at a rate of 500 mJ/cm² using a metal halide lamp, thereby obtaining a polycarbonate with a hard coat layer. The resultant polycarbonate with a hard coat layer was evaluated as follows. Table 2 shows the results.

(Surface Hardness Measurement Test)

In conformity with a pencil hardness test (JIS-K5400), pencils with different hardnesses were touched at an angle of 90 degrees on the surface of the polycarbonate with a hard coat layer, and the surface was scratched at a load of 750 g to determine the hardness of the pencil when the surface was damaged.

(Antifouling Property (Fingerprint Resistance) Evaluation Test)

A fingerprint was attached to the surface of the polycarbonate with a hard coat layer, and the surface was wiped back and forth three times with a cotton cloth at a load of 500 g to evaluate fingerprint removing property based on the following criteria.

∘: Having no fingerprint on the surface of the film
x: Having a fingerprint on the surface of the film

(Vickers Hardness Test)

A load was applied to the surface of the polycarbonate with a hard coat layer using a Vickers hardness tester (type DUH-W201S, manufactured by Shimadzu Corporation) at a test load of 30 gf and a load rate of 7.2 gf/s, and the length of a diagonal line of a square mark on the surface was measured.

(Evaluation Method: Chemical Resistance Test)

Toluene was dropped onto the surface of the hard coat layer (resin layer), and the chemical resistance of the surface was evaluated based on the following criteria.

∘: Having no abnormal appearance such as dissolution or roughness on the surface of the hard coat layer
x: Having abnormal appearance such as dissolution or roughness on the surface of the hard coat layer

TABLE 2

| | Exam | Exam- | Exam- | Exam- |
|---|---|---|---|---|
| | ple 1 | ple 2 | ple 3 | ple 4 |
| Surface hardness | 7H | 7H | 7H | 7H |
| measurement test | | | | |
| Antifouling property | ∘ | ∘ | ∘ | ∘ |
| evaluation test | | | | |
| Vickers hardness | Measure- | Measure- | Measure- | 46 |
| test | ment is in | ment is in | ment is in | |
| | progress. | progress. | progress. | |
| Chemical resistance | ∘ | ∘ | ∘ | ∘ |
| test | | | | |

| | Comparative | Comparative |
|---|---|---|
| | Example 1 | Example 2 |
| Surface hardness | B | 4H |
| measurement test | | |
| Antifouling property | x | x |
| evaluation test | | |
| Vickers hardness | Measure- | 20 |
| test | ment is in | |
| | progress. | |
| Chemical resistance | ∘ | x |
| test | | |

### Example 2

A film laminate was produced in the same manner as in Example 1 and attached to one side of a polycarbonate (PC-1151, manufactured by Teijin Limited, 200 mm×200 mm×0.5 mm in thickness) using a double-sided pressure-sensitive adhesive tape (manufactured by NITTO DENKO CORPORATION), thereby obtaining a polycarbonate with a hard coat layer. After that, the product was evaluated in the same manner as in Example 1. Table 2 shows the results.

### Example 3

80 parts of trimethylolpropane triacrylate (KS-TMPA, manufactured by NIPPON KAYAKU Co., Ltd.), 20 parts of a silsesquioxane oligomer (the following structural formula 2), and 2.5 parts of hydroxycyclohexyl phenyl ketone (IRGACURE 184, manufactured by Ciba Specialty Chemicals Inc.) were homogeneously mixed by stirring, and the mixture was defoamed to prepare a liquid photocurable resin composition. After that, the liquid photocurable resin composition was loaded into an application device and applied simultaneously to both sides of a transparent plastic film (polyethylene terephthalate (PET) film having a width of 300 mm, a thickness of 0.1 mm, and a light transmittance at a wavelength of 550 nm of 90% or more) which was wound off at a rate of 1 m/min by a slot die coater method. Then, a transparent cover film (polyethylene terephthalate film having a width of 300 mm, a thickness of 0.1 mm, and a light transmittance of 90% or more) was pressure-bonded to the applied photocurable resin from both sides. The resultant was irradiated with ultraviolet light from both sides at a rate of 500 mJ/cm² using a metal halide lamp. The thickness of one of the resin layers obtained by curing was 0.05 mm. Subsequently, the transparent cover film was removed by peeling, thereby obtaining a film laminate (total thickness: 0.2 mm) having a three-layer structure of “resin layer (thickness: 0.05 mm)-transparent plastic film (thickness: 0.1 mm)-resin layer (thickness: 0.05 mm).” It should be noted that the reaction rate of each resin layer was measured and found to be 85% or more. In addition, the light transmittance and glass transition temperature of the resin layer and the glass transition temperature of the transparent plastic film were determined in the same manner as in Example 1. Table 1 shows the results.

### Structural Formula 2

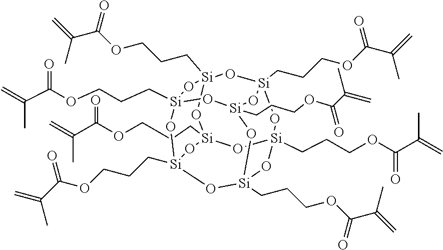 [SMILES: C=C(C)C(=O)OCCC[Si]12O[Si]3(CCCOC(=O)C(=C)C)O[Si]4(CCCOC(=O)C(=C)C)O[Si](CCCOC(=O)C(=C)C)(O1)O[Si]1(CCCOC(=O)C(=C)C)O[Si](CCCOC(=O)C(=C)C)(O2)O[Si](CCCOC(=O)C(=C)C)(O3)O[Si](CCCOC(=O)C(=C)C)(O4)O1]

Then, in the same manner as in Example 1, a cationic photocurable adhesive (manufactured by Kyoritsu Chemical & Co., Ltd.) was applied by casting onto a polycarbonate (PC-1151, manufactured by Teij in Limited, 200 mm×200 mm×0.5 mm in thickness), and the film laminate obtained above (total thickness: 0.2 mm) was attached to the whole surface of one side of the polycarbonate, pressure-bonded, and irradiated with ultraviolet light from both sides at a rate of 500 mJ/cm² using a metal halide lamp, thereby obtaining a polycarbonate with a hard coat layer. The resultant polycarbonate with a hard coat layer was evaluated in the same manner as Example 1. Table 2 shows the results.

### Example 4

25 parts of a silsesquioxane oligomer (the following structural formula 3), 65 parts of dipentaerythritol (trade name: “KAYARAD DPHA,” manufactured by NIPPON KAYAKU CO., LTD.), 10 parts of dimethyloltricyclodecane diacrylate (trade name: “LIGHT ACRYLATE DCP-A,” manufactured by Kyoeisha Chemical Co., Ltd.), and 2.5 parts of hydroxycyclohexyl phenyl ketone (trade name: “IRGACURE 184,” manufactured by Ciba Specialty Chemicals Inc.) were homogeneously mixed by stirring, and the mixture was defoamed to prepare a liquid photocurable resin composition. After that, the liquid photocurable resin composition was loaded into an application device and applied simultaneously onto both sides of a transparent plastic film (polyethylene terephthalate (PET) film having a width of 300 mm, a thickness of 0.1 mm, and a light transmittance at a wavelength of 550 nm of 90% or more) which was wound off at a rate of 1 m/min by a slot die coater method. Then, a transparent cover film (polyethylene terephthalate film having a width of 300 mm, a thickness of 0.1 mm, and a light transmittance of 90% or more) was pressure-bonded to the applied photocurable resin from both sides. The resultant was irradiated with ultraviolet light from both sides at a rate of 500 mJ/cm² using a metal halide lamp. The thickness of one of the resin layers obtained by curing was 0.05 mm. Subsequently, the transparent cover film was removed by peeling, thereby obtaining a film laminate (total thickness: 0.2 mm) having a three-layer structure of “resin layer (thickness: 0.05 mm)-transparent plastic film (thickness: 0.1 mm)-resin layer (thickness: 0.05 mm).” It should be noted that the reaction rate of each resin layer was measured and found to be 85% or more. In addition, the light transmittance and glass transition temperature of the resin layer and the glass transition temperature of the transparent plastic film were determined in the same manner as in Example 1. Table 1 shows the results.

### Structural Formula 3

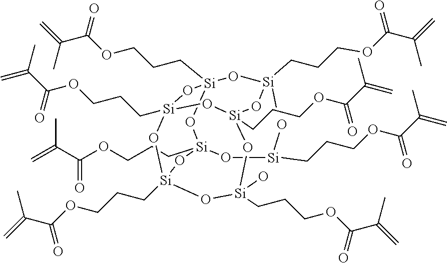

Then, in the same manner as in Example 1, a cationic photocurable adhesive (manufactured by Kyoritsu Chemical & Co., Ltd.) was applied by casting onto a polycarbonate (PC-1151, manufactured by Teijin Limited, 200 mm×200 mm×0.5 mm in thickness), and the film laminate obtained above (total thickness: 0.2 mm) was attached to the whole surface of one side of the polycarbonate, pressure-bonded, and irradiated with ultraviolet light from both sides at a rate of 500 mJ/cm² using a metal halide lamp, thereby obtaining a polycarbonate with a hard coat layer. The resultant polycarbonate with a hard coat layer was evaluated in the same manner as Example 1. Table 2 shows the results.

### Comparative Example 1

In the same manner as in Example 1, a cationic photocurable adhesive (manufactured by Kyoritsu Chemical & Co., Ltd.) was applied by casting onto a polycarbonate (PC-1151, manufactured by Teijin Limited, 200 mm×200 mm×0.5 mm in thickness), and a polyethylene terephthalate (PET) film having a thickness of 0.1 mm and a light transmittance at a wavelength of 550 nm of 90% or more was attached to the whole surface of one side of the polycarbonate, pressure-bonded, and irradiated with ultraviolet light from both sides at a rate of 500 mJ/cm² using a metal halide lamp, thereby obtaining a polycarbonate with a hard coat layer. The resultant polycarbonate with a hard coat layer was evaluated in the same manner as Example 1. Table 2 shows the results.

### Comparative Example 2

In the same manner as in Example 1, a cationic photocurable adhesive (manufactured by Kyoritsu Chemical & Co., Ltd.) was applied by casting onto a polycarbonate (PC-1151, manufactured by Teijin Limited, 200 mm×200 mm×0.5 mm in thickness), and an acrylic film (MR200, manufactured by MITSUBISHI RAYON CO., LTD., thickness: 0.5 mm, light transmittance at a wavelength of 550 nm: 90% or more) was attached to the whole surface of one side of the polycarbonate, pressure-bonded, and irradiated with ultraviolet light from both sides at a rate of 500 mJ/cm² using a metal halide lamp, thereby obtaining a polycarbonate with a hard coat layer. The resultant polycarbonate with a hard coat layer was evaluated in the same manner as Example 1. Table 2 shows the results.

### INDUSTRIAL APPLICABILITY

The present invention provides the polycarbonate with a hard coat layer, which is excellent in transparency, high surface hardness, weather resistance, chemical resistance, antifouling property, durability, and productivity. The resultant polycarbonate with a hard coat layer is used for glass for a display device such as a CRT display, a liquid crystal display, a plasma display, or an organic EL display, and various materials typified by protective glass, window glass for a building material, window glass for a vehicle, and is particularly suitable for a material required to have a reduced thickness. The present invention, which enables production of such polycarbonate with a hard coat layer, has very high industrial applicability.

### REFERENCE SIGNS LIST

1: transparent plastic film
2: adhesive layer
3: polycarbonate resin
4: hard coat layer (resin layer)

1. A polycarbonate with a hard coat layer, comprising a hard coat film bonded to a base formed of a polycarbonate resin via an adhesive layer, wherein the hard coat film includes, on an outermost surface, a resin layer that is obtained by curing a photocurable resin composition containing at least a photocurable polyhedral silsesquioxane resin, and that has a light transmittance at a wavelength of 550 nm of 90% or more, a glass transition temperature of 250° C. or more, and a thickness of 10 μm or more and 200 μm or less.

2. A polycarbonate with a hard coat layer according to claim 1, wherein the hard coat layer is obtained by laminating the resin layer and a transparent plastic film having a glass transition temperature of 70° C. or more and 220° C. or less.

3. A polycarbonate with a hard coat layer according to claim 1, wherein the photocurable resin composition for forming the resin layer contains the photocurable polyhedral silsesquioxane resin at a concentration of 3 wt % or more.

4. A polycarbonate with a hard coat layer according to claim 1, wherein the photocurable polyhedral silsesquioxane resin comprises a polyhedral silsesquioxane resin represented by the following general formula (2):
[RSiO_{3/2}]ₙ (2)
where R represents an organic functional group having any one of a (meth)acryloyl group, a glycidyl group, or a vinyl group, and n represents 8, 10, 12, or 14.

5. A polycarbonate with a hard coat layer according to claim 4, wherein the photocurable polyhedral silsesquioxane resin comprises a polyhedral silsesquioxane resin that is obtained by: hydrolyzing and partially condensing a silicon compound represented by the following general formula (1):
RSiX₃ (1)
where R represents an organic functional group having any one of a (meth)acryloyl group, a glycidyl group, or a vinyl group, or the following general formula (3), (4), or (5): 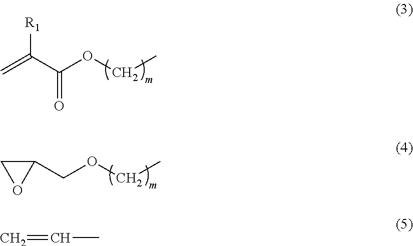
where m represents an integer of 1 to 3, and R₁ represents a hydrogen atom or a methyl group, and X represents a hydrolyzable group in a presence of an organic polar solvent and a basic catalyst; and recondensing the resultant hydrolysis product in a presence of a non-polar solvent and a basic catalyst.

6. A polycarbonate with a hard coat layer according to claim 1, wherein the adhesive layer is formed of a photocurable resin.

7. A polycarbonate with a hard coat layer according to claim 2, wherein the photocurable resin composition for forming the resin layer contains the photocurable polyhedral silsesquioxane resin at a concentration of 3 wt % or more.

8. A polycarbonate with a hard coat layer according to claim 2, wherein the photocurable polyhedral silsesquioxane resin comprises a polyhedral silsesquioxane resin represented by the following general formula (2):
[RSiO_{3/2}]ₙ (2)
where R represents an organic functional group having any one of a (meth)acryloyl group, a glycidyl group, or a vinyl group, and n represents 8, 10, 12, or 14.

9. A polycarbonate with a hard coat layer according to claim 8, wherein the photocurable polyhedral silsesquioxane resin comprises a polyhedral silsesquioxane resin that is obtained by: hydrolyzing and partially condensing a silicon compound represented by the following general formula (1):
RSiX₃ (1)
where R represents an organic functional group having any one of a (meth)acryloyl group, a glycidyl group, or a vinyl group, or the following general formula (3), (4), or (5): 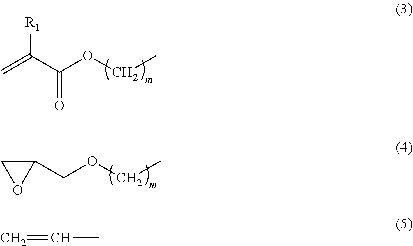
where m represents an integer of 1 to 3, and R₁ represents as hydrogen atom or a methyl group, and X represents a hydrolyzable group in a presence of an organic polar solvent and a basic catalyst; and recondensing the resultant hydrolysis product in a presence of a non-polar solvent and a basic catalyst.

10. A polycarbonate with a hard coat layer according to claim 2, wherein the adhesive layer is formed of a photocurable resin.
